(19) United States
(12) Patent Application Publication
(10) Pub. No.: US 2007/0268833 A1
(43) Pub. Date: Nov. 22, 2007

(54) Systems and methods for measuring two or more input signals using a single input on a measuring device

(76) Inventor: Marcus K. daSilva, Portland, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(21) Appl. No.: 11/437,604

(22) Filed: May 18, 2006

(51) Int. Cl. H04L 12/26

(52) U.S. Cl. 370/241

(57) ABSTRACT

A method for measuring two or more input signals using a single-input measuring device is described. Test equipment that comprises a single-input measuring device is provided. A first input is received. A second input is received. The second input is delayed by a time delay T to provide a delayed second input. The first input and the delayed second input are combined to provide a combined input signal. The combined input signal is provided to the test equipment.

### TECHNICAL FIELD

The present invention relates generally to test equipment. More specifically, the present invention relates to systems and methods for measuring two or more input signals using a single input on a measuring device.

### BACKGROUND

Technological innovation in Radio Frequency (RF) has accelerated steadily over the last several decades and continues to do so today. To resist interference, avoid detection, and improve capacity, modern radar systems and commercial communications networks have become extremely complex, and both typically employ sophisticated combinations of RF techniques such as bursting, frequency hopping, code division multiple access, and adaptive modulation. Designing these types of advanced RF equipment and successfully integrating them into working systems are extremely complicated tasks.

At the same time, the increasingly widespread success of cellular technology and wireless data networks has caused the cost of basic RF components to plummet. This has enabled manufacturers outside of the traditional military and communications realms to embed relatively simple RF devices into all sorts of commodity products. RF transmitters have become so pervasive that they can be found in almost any imaginable location: consumer electronics in homes, medical devices in hospitals, industrial control systems in factories, and even tracking devices implanted underneath the skin of livestock, pets, and people.

As RF signals have become ubiquitous in the modem world, so too have problems with interference between the devices that generate them. Products such as mobile phones that operate in a licensed spectrum must be designed not to transmit RF energy into adjacent frequency channels, which is especially challenging for complex multi-standard devices that switch between different modes of transmission and maintain simultaneous links to different network elements. Simpler devices that operate in unlicensed frequency bands must also be designed to function properly in the presence of interfering signals, and government regulations often dictate that these devices are only allowed to transmit in short bursts at low power levels.

The transition to digital broadcast technologies has created new business challenges and requirements for video and audio monitoring, increasing the need for tools that quickly verify the quality of digital signals. Monitoring tools are used to detect and diagnose problems affecting the quality of digital video and audio transmissions. Effective monitoring tools reduce time and effort in fault detection, problem diagnosis and failure recovery.

Wireless data networks allow systems to share information through wireless technologies. A wireless LAN (local area network) is one example of a wireless data network. A wireless LAN typically transmits over the air in the 2.4 GHz or 5 GHz frequency band. A wireless access point is wired into the LAN and enables systems to connect wirelessly to the LAN though a radio frequency. As wireless data networks continue to advance, and as other technologies that use RF signals are put in place, the likelihood of interference or other problems with the RF signals increases. The use of effective monitoring tools or test equipment helps detect problems in wireless data networks.

The increasing rate of demand for more efficient methods of communicating with others has led to the increased use of mobile telecommunications devices, such as cellular telephones. Cellular telephones provide users the ability to communicate by telephone without the restrictions of a wire-based telephone. Some cellular telephones also provide users the ability to engage in numerous online services. There are many different providers of cellular services, as well as many different kinds of technologies used in cellular telephones. Some of the cellular telephone technologies include TDMA (Time Division Multiple Access), CDMA (Code Division Multiple Access) and GSM (Global System for Mobile Communications). Regardless of the specific technology being used, the ability to diagnose and fix problems is important to the continued use and advancement of cellular technologies.

Multiple-Input Multiple-Output (MIMO) wireless systems increase user capacity in a variety of environments. MIMO systems use multiple antennas at both the transmitter and the receiver. MIMO systems provide a number of benefits including an increase in capacity, an increase in spectral efficiency, a reduction of fading, and an improved resistance to interference. With a MIMO system, the same information is typically transmitted on all of the antennas, but different coding is used. Measuring MIMO Radio Frequency (RF) devices traditionally requires RF measurement equipment with as many input connections as there are RF outputs from the device being tested.

In order to overcome these evolving challenges mentioned above, it is crucial for today's engineers and scientists to be able to reliably detect and characterize RF signals that change over time, something not easily done with traditional measurement tools. As shown from the above discussion, there is a need for systems and methods that will improve the ability to capture and analyze electronic signals. Benefits may be realized by providing increased functionality to capture, process and analyze electronic signals. Benefits may further be realized by providing this increased functionality at a lower cost.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram of a system for measuring two or more input signals using a single-input measuring device;

FIG. 2 is a block diagram of an embodiment of a system for measuring two or more input signals using a single-input measuring device illustrating example waveforms;

FIG. 3 is a block diagram of an embodiment of a system for measuring four input signals using a single-input measuring device illustrating example waveforms;

FIG. 4 is a block diagram of one possible time delay component;

FIG. 5 is a block diagram illustrating another possible time delay component;

FIG. 6 is a general hardware block diagram of an embodiment of test equipment being used to measure two or more input signals using a single input;

FIG. 7 is a general block diagram of an embodiment of a real-time spectrum analyzer being used to measure two or more input signals using a single input; and

FIG. 8 is a flow diagram of an embodiment of a method measuring two or more input signals using a single-input measuring device.

### DETAILED DESCRIPTION

A method for measuring two or more input signals using a single-input measuring device is described. Test equipment that comprises a single-input measuring device is provided. A first input is received. A second input is received. The second input is delayed by a time delay T to provide a delayed second input. The first input and the delayed second input are combined to provide a combined input signal. The combined input signal is provided to the test equipment.

In an embodiment, the method for measuring two or more input signals using a single-input measuring device may be used with a Multiple-Input Multiple-Output (MIMO) wireless system. Further, an autocorrelation may be performed by the test equipment on the combined input signal. In another embodiment, the first input and the second input may both be radio frequency signals.

The time delay may be calibrated. In addition, the time delay may be calibrated such that the time delay is greater than the timing skew between the first input and the second input.

The test equipment may be implemented in various embodiments. For example, the test equipment may include a real-time spectrum analyzer, an oscilloscope, a logic analyzer, and the like.

An apparatus for measuring two or more input signals using a single input on test equipment is also disclosed. The apparatus comprises test equipment that includes a test input for receiving an input signal into the test equipment. A summing block is included in electronic communication with the test input. A first input is in electronic communication with the summing block. A time delay block is in electronic communication with the summing block. A second input in electronic communication with the time delay block.

In an embodiment, the apparatus may include one or more antennas to receive the first input and the second input.

In a further embodiment, the apparatus may include a second time delay block in electronic communication with the summing block and a third input in electronic communication with the second time delay block.

A method for converting two or more spatially separated signals into two or more temporally separated signals to measure the signals using a single-input measuring device is also described. Test equipment that comprises a single-input measuring device is provided. A first input is received. A second input is received. The first input and the second input are spatially separated signals. The second input is delayed by a time delay T to provide a delayed second input. The first input and the delayed second input are combined to provide a combined input signal. The combined input signal includes a temporally separated signal derived from the spatially separated signal. The combined input signal is provided to the test equipment.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

Communications systems are used for transmission of information from one device to another. Prior to transmission, information is encoded into a format suitable for transmission over a communication channel. A wireless signal containing the encoded information is then transmitted over the communication channel. A communication receiver is used to receive the wireless signal.

Typically, the received wireless signal includes a plurality of multipath components. These multipath components are different versions of the wireless signal that are generated by reflections from structures and natural formations. The different multipath components experience degradation and additive noise as they travel through the communication channel. Thus, each multipath component includes a signal component that corresponds to the transmitted signal but may be distorted or degraded and a noise component that does not correspond to the transmitted signal.

One method to address multipath is to use receiver diversity. Receiver diversity typically provides multiple antennas separated by some fraction of a wavelength. With receiver diversity it is possible to switch between the antennas so that the system is getting the best signal. Selecting a particular antenna to get the signal with the best Signal to Noise Ratio (SNR) is referred to as antenna selection diversity.

A piece of test equipment that would be put in place of the receiver would typically be testing the transmitter and the transmission of the signals. The current systems and methods below would allow one receiver to be used to process the different signals from each different antenna, as will be discussed more fully below.

Multiple-Input Multiple-Output (MIMO) wireless systems increase user capacity in a variety of environments. MIMO systems use multiple antennas at both the transmitter and the receiver. MIMO systems provide a number of benefits including an increase in capacity, an increase in spectral efficiency, a reduction of fading, and an improved resistance to interference. With a MIMO system, the same information is typically transmitted on all of the antennas, but different coding is used. MIMO gives the system spatial diversity. One reference that discusses MIMO is by S. M. Alamouti, “A Simple Transmit Diversity Technique for Wireless Communications”, IEEE Journal on Select Areas in Communications, vol. 16, no. 8, October 1998, which is incorporated herein by reference.

Measuring MIMO Radio Frequency (RF) devices traditionally requires RF measurement equipment with as many input connections as there are RF outputs from the device being tested. While sequential testing of the multiple outputs is possible, it fails to test the simultaneous nature of modern MIMO devices. The current systems and methods below would allow one receiver to be used to process the different signals from each different antenna, as will be discussed more fully below.

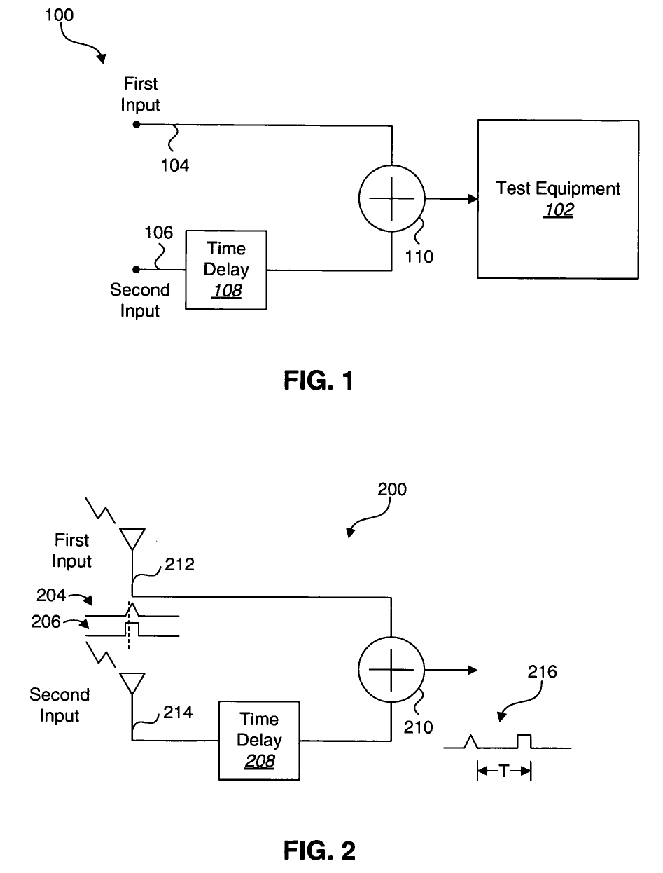

FIG. 1 is a block diagram of a system 100 for measuring two or more input signals using a single-input measuring device 102. This technique provides for accepting two (or more) signals, a first input 104 and a second input 106, that may otherwise be identical in one or more respects (same frequency, modulation, time sent, or other parameters) and effectively measuring or analyzing them separately. The input signals 104, 106 may be RF signals. A time delay 108 is introduced into the second input 106. This delay allows a single RF conversion and DSP processor (not shown) in the test equipment 102 to see the separate signals as simply delayed in time. The different inputs 104, 106 are then combined by a summing block 110.

The multiple signals 104, 106 being tested are usually the same frequency and often the same modulation. As such, they would normally require separate RF processing and acquisition. One implementation with separate RF processing and acquisition would use multiple instruments 102 for separate acquisitions and communication between them for the signal processing that accomplishes the measurements. If multiple pieces of test equipment 102 were required, the cost of the testing is higher, and sometimes much higher, than if a single piece of test equipment 102 were required. In addition, the synchronization between the multiple pieces of test equipment 102 would be complex and would complicate the testing procedure substantially. The present systems and methods do not require multiple pieces of test equipment 102 but provide a system 100 for measuring two or more input signals using a single-input measuring device 102.

If the system 100 of FIG. 1 were being used with MIMO, the system 100 delays the second input 106 signal and uses digital signal processing, specifically auto-correlation, that looks for multiple copies of the signal at different time offsets. These multiple copies will be evident as correlation peaks at a time separation equal to the introduced delay. This is particularly useful with digitally modulated signals.

The delay introduced by the time delay 108 needs to be sufficient so that the separate signals can be distinguished, but short enough so that a repetitive test transmission will not be delayed more than one half of the repetition interval. This will avoid ambiguity in the signal separation.

FIG. 2 is a block diagram of an embodiment of a system 200 for measuring two or more input signals 204, 206 using a single-input measuring device illustrating example waveforms. Any number of input signals may be used with the present systems and methods herein. The specific examples herein are only meant to be exemplary and are not meant to be limiting to the specific embodiment shown. The first input 204 is an RF signal with the illustrative waveform as shown. Please note that the waveforms illustrated herein are meant to help explain the present systems and methods and are not meant to illustrate real-world signals. The first input 204 is received by an antenna 212, has no time delay block, but simply goes directly into the summing block 210. The second input 206 is received at an antenna 214, goes through a time delay block 208 which has a time delay of time T. After the time delay 208 the second input 214 feeds into the summing block 210. The output waveform 216 is shown illustrating that the second input 206 has been delayed by time T. The time delay T allows a single RF conversion and DSP processor (not shown) in the test equipment 102 to see the separate signals as simply delayed in time, which is illustrated by the output waveform 216.

If this system were being used with MIMO, it may be desirable to obtain the timing skew. To obtain the timing skew between the two input signals 204, 206, the system could simply subtract the time T from the output waveform 216. Once the time T had been subtracted, the timing difference between the signals 204, 206 would be the timing skew.

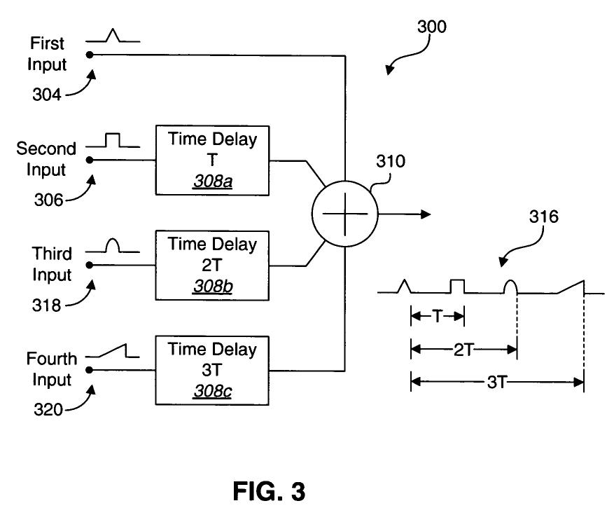

FIG. 3 is a block diagram of an embodiment of a system 300 for measuring four input signals 304, 306, 318, 320 using a single-input measuring device illustrating example waveforms. Multiple inputs, including two or more, may be all delayed in time in implementing a system according to the present embodiments. The first input 304 has no time delay and has the illustrative waveform as shown. The second input 306 has the illustrative waveform as shown and is connected to a time delay 308a of time T. The third input 318 has the illustrative waveform as shown and is connected to a time delay 308b of time 2T. The fourth input 320 has the illustrative waveform as shown and is fed into a time delay 308c of time 3T. All of the inputs 304, 306, 318, 320 are combined by the summing block 310. The output waveform 316 is shown illustrating that three of the waveforms have been delayed by time T or a multiple thereof. The delays introduced by different time delay blocks do not have to be integer multiples of the first time delay block. The use of T, 2T and 3T in FIG. 3 were only used for simplicity and to illustrate the present systems and methods. The delays could have been T, XT and YT where X and Y are any real numbers, whether integers or floating point numbers.

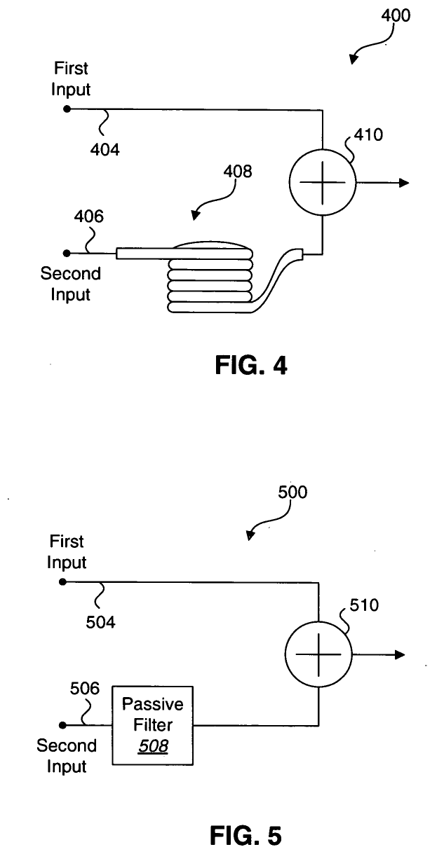

FIG. 4 is a block diagram of one possible time delay component 408. There are several ways to introduce an analog delay into a signal channel. A simple transmission line may be used for this delay. One simple solution to introduce a time delay is to simply use an appropriate length of coax cable 408. Coax cable 408 of an appropriate length will introduce a time delay into the signal. As shown the first input 404 is fed into the summing block 410. The second input 406 is connected to the coax cable 408, which is connected to the summing block 410.

In electronics and derivative fields such as telecommunications, a delay line is rigorously defined as a single-input-channel device, in which the output channel state at a given instant, t, is the same as the input channel state at the instant t-n, where n is a number of time units, i.e., the input sequence undergoes a delay of n time units, such as n femtoseconds, nanoseconds, or microseconds. (The delay line may have additional taps yielding output channels with values less than n.) In other words, the device introduces a delay of a certain amount of time between its input and output. A delay line may be used for the time delay.

FIG. 5 is a block diagram illustrating another possible time delay component 508. As shown, the embodiment of FIG. 5 includes a passive filter 508. A passive filter 508, for example a low pass filter designed to have a fixed time delay as is currently known, may be used to introduce a time delay as needed. As shown the first input 504 is fed into the summing block 510. The second input 506 is connected to the passive filter 508, which is connected to the summing block 510.

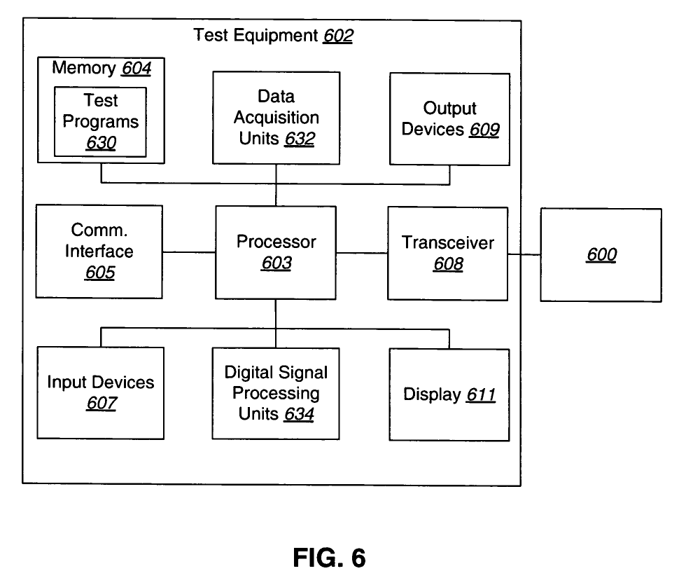

FIG. 6 is a general hardware block diagram of an embodiment of test equipment 602 as part of a system for measuring two or more input signals using a single-input measuring device. The test equipment 602 shown in FIG. 6 is an example of one possible single-input measuring device 102. Various kinds of test equipment 602 may be used with the systems and methods herein including, but not limited to, oscilloscopes, logic analyzers, video test equipment, network management and diagnostic equipment, real-time spectrum analyzers, etc.

The test equipment 602 may include a processor 603, memory 604, a communications interface 605, multiple input devices 607, multiple output devices 609 and a display 611. The processor 603 may also be referred to as a CPU. The processor 603 may be embodied as a microprocessor, a microcontroller, a programmable gate array or integrated circuit, a digital signal processor (DSP) or other device known in the art. The processor 603 typically performs logical and arithmetic operations based on program instructions, or logical definitions, stored within the memory 604 or circuits contained within the processor 603.

Display devices 611 used with embodiments disclosed herein may utilize any suitable image projection technology, such as a cathode ray tube (CRT), liquid crystal display (LCD), light-emitting diode (LED), gas plasma, electroluminescence, or the like. The display 611 may include a display controller. Alternatively a display controller may be included separately. The display controller may be used to convert data stored in the memory 604 into text, graphics, and/or moving images (as appropriate) shown on the display device 611.

The memory 604 provides instructions and data to the processor 603. A portion of the memory 604 may also include non-volatile random access memory (NVRAM). As used herein, the term “memory” 604 is broadly defined as any electronic component capable of storing electronic information, and may be embodied as read only memory (ROM), random access memory (RAM), magnetic disk storage media, optical storage media, flash memory devices in RAM, on-board memory included with the processor 603, EPROM memory, EEPROM memory, registers, etc. The memory 604 typically stores program instructions and other types of data. The program instructions may be executed by the processor 603 to implement test programs 630 or procedures. The test programs 630 are used to process and analyze the data obtained by the piece of test equipment 602.

A piece of test equipment 602 typically also includes one or more input devices 607 and one or more output devices 609. Examples of different kinds of input devices 607 include a keyboard, keypad, switches, knobs, mouse, microphone, remote control device, button, joystick, trackball, touchpad, lightpen, sensors, etc. Examples of different kinds of output devices 609 may include an LCD screen, a speaker, printer, etc.

A transceiver 608 may be included to allow the reception and/or transmission of data by the test equipment 602. An embodiment of a system 600 for measuring two or more input signals using a single-input measuring device may be connected to the test equipment 602 and be electrically coupled to the transceiver 608.

The test equipment 602 may also include one or more communication interfaces 605 for communicating with other electronic devices. The communication interfaces 605 may be based on wired communication technology, wireless communication technology, or both. Examples of different types of communication interfaces 605 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a ZigBee wireless communication adapter, WLAN, an ultra wideband wireless communication adapter, and so forth.

One or more data acquisition units 632 are included in the test equipment 602 to acquire data for capture and analysis. The data acquisition units 632 may include analog to digital converters, filters, amplifiers, etc., as needed to capture and store the data. The data acquired by the data acquisition units 632 is stored in the memory 604.

Digital signal processing units 634 may also be included in the test equipment 602 to perform various kinds of digital signal processing on any acquired data. The processor 603 has the ability to perform some data processing, but in some environments faster processing is required. Dedicated digital signal processing units 634 can usually provide significant performance increases over what the processor 603 can provide.

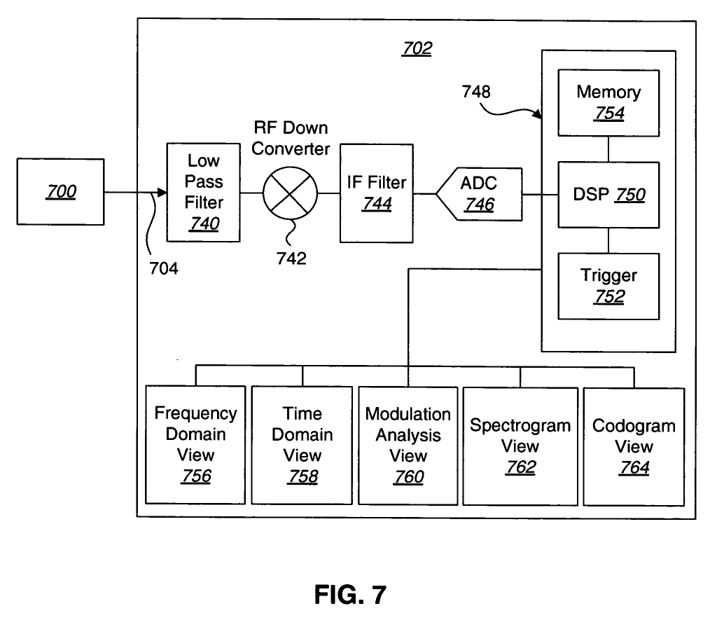

FIG. 7 is a general block diagram of an embodiment of a real-time spectrum analyzer 702 being used to measure two or more input signals using a single input. A real-time spectrum analyzer 702 is one embodiment of test equipment 602.

The real-time spectrum analyzer 702 is designed to address the measurement challenges associated with transient and dynamic RF signals. The real-time spectrum analyzer 702 has the ability to trigger on an RF signal, capture it into memory, and analyze it in multiple domains. This makes it possible to reliably detect and characterize RF signals that change over time.

The input 704 is obtained from an embodiment of a system 700 for measuring two or more input signals using a single-input measuring device. The input signal 704 that is to be analyzed is sent through a low pass filter 740 after which it is down-converted by an RF down-converter 742 to a fixed Intermediate Frequency (IF) that is related to the maximum real-time bandwidth of the real-time spectrum analyzer 702. This RF front-end can be tuned across the entire frequency range of the instrument 702.

The signal is then filtered by an IF filter 744, digitized by the Analog to Digital Converter (ADC) 746, and passed to the DSP engine 748 that manages the instrument's digital signal processing 750, triggering 752, and memory 754, and analysis functions.

The DSP engine 748 enables the real-time spectrum analyzer 702 to provide a user with many different and useful views of the input signal. A frequency domain view 756 may be provided, as well as a time domain view 758. Furthermore, views of modulation analysis 760 may be provided. A spectrogram is a frequency versus time versus amplitude display where the frequency is represented on the x-axis and time on the y-axis. The power is typically expressed by the color. A spectrogram view 762 may be provided. The analyzer 702 may also provide a codogram view 764. A codogram view 764 is a code channel versus time versus power display where the CDMA code channel is represented on the x-axis and time respectively on the y-axis. The power level is expressed by the color.

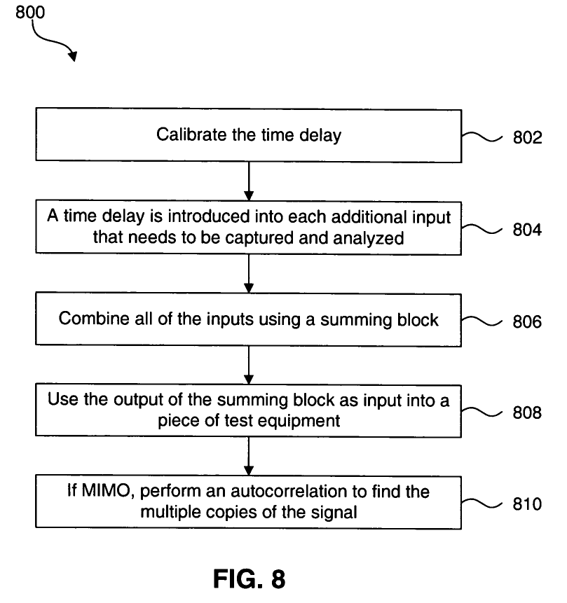

FIG. 8 is a flow diagram of an embodiment of a method 800 for measuring two or more input signals using a single-input measuring device. First the time delay is calibrated 802. The delay introduced by the time delay block 108 needs to be sufficient so that the separate signals can be distinguished, but short enough so that a repetitive test transmission will not be delayed more than one half of the repetition interval. This will avoid ambiguity in the signal separation.

If the system is being used with MIMO, one way to calibrate 802 the time delay is to first determine the timing skew between the two signals. One way to determine the timing skew is to perform a cross correlation between the two signals. Once the timing skew has been determined, the delay may be set so that it is greater than the timing skew such that the separate signals can be distinguished.

For each additional input that needs to be captured and analyzed, a time delay is introduced 804 into the additional inputs. Specific examples of this were shown in FIGS. 1-3 above. Then all of the inputs are combined 806 by a summing block. The output of the summing block is input 808 into a piece of test equipment. If the system is being used with MIMO, the test equipment may then perform 810 an autocorrelation to find the multiple copies of the signal.

Through use of the present systems and methods a single-input measuring device is used to measure multiple input signals. Two or more spatially separated signals are converted into two temporally separated signals.

One possible application of the present systems and methods is with a MIMO system. With MIMO, because the time delay T is known, the system can subtract out the T and know the timing skew. Furthermore, the systems and methods delay the second (and any more than two) signal and use DSP processing (auto-correlation) to identify multiple copies of the signal at different time offsets. These multiple copies will be evident as correlation peaks at a time separation equal to the introduced delay. This is particularly useful with digitally modulated signals.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for measuring two or more input signals using a single-input measuring device, the method comprising:
providing test equipment that comprises a single-input measuring device;
receiving a first input;
receiving a second input;
delaying the second input by a time delay T to provide a delayed second input;
combining the first input and the delayed second input to provide a combined input signal; and
providing the combined input signal to the test equipment.

2. The method of claim 1, wherein the method is being used with a Multiple-Input Multiple-Output (MIMO) wireless system and further comprises performing an autocorrelation by the test equipment on the combined input signal.

3. The method of claim 1, wherein the first input and the second input are both radio frequency signals.

4. The method of claim 1, wherein the method further comprises calibrating the time delay.

5. The method of claim 1, wherein the method further comprises calibrating the time delay such that the time delay is greater than the timing skew between the first input and the second input.

6. The method of claim 1, wherein the test equipment comprises a real-time spectrum analyzer.

7. The method of claim 1, wherein the test equipment comprises an oscilloscope.

8. The method of claim 1, wherein the test equipment comprises a logic analyzer.

9. An apparatus for measuring two or more input signals using a single input on test equipment, the apparatus comprising:
test equipment that includes a test input for receiving an input signal into the test equipment;
a summing block in electronic communication with the test input;
a first input in electronic communication with the summing block;
a time delay block in electronic communication with the summing block; and
a second input in electronic communication with the time delay block.

10. The apparatus of claim 9, further comprising one or more antennas to receive the first input and the second input.

11. The apparatus of claim 9, wherein the test equipment comprises a real-time spectrum analyzer.

12. The apparatus of claim 9, wherein the test equipment comprises an oscilloscope.

13. The apparatus of claim 9, wherein the test equipment comprises a logic analyzer.

14. The apparatus of claim 9 further comprising:
a second time delay block in electronic communication with the summing block; and
a third input in electronic communication with the second time delay block.

15. A method for converting two or more spatially separated signals into two or more temporally separated signals to measure the signals using a single-input measuring device, the method comprising:
providing test equipment that comprises a single-input measuring device;
receiving a first input;
receiving a second input, wherein the first input and the second input are spatially separated signals;
delaying the second input by a time delay T to provide a delayed second input;
combining the first input and the delayed second input to provide a combined input signal, wherein the combined input signal includes a temporally separated signal derived from the spatially separated signal; and
providing the combined input signal to the test equipment.

16. The method of claim 15, wherein the method further comprises performing an autocorrelation by the test equipment on the combined input signal.

17. The method of claim 15, wherein the first input and the second input are both radio frequency signals.
